(19) United States
(12) Patent Application Publication
(10) Pub. No.: US 2026/0255137 A1
(43) Pub. Date: Aug. 27, 2026

(54) SYSTEMS AND METHODS FOR VEHICULAR SENSOR DATA INTERROGATION

(71) Applicant: Toyota Motor Engineering & Manufacturing North America, Inc., Plano, TX (US)

(72) Inventors: Seyhan Ucar, Mountain View, CA (US); Divya Sai Toopran, Sunnyvale, CA (US); Emrah Akin Sisbot, Menlo Park, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/064,030

(22) Filed: Feb. 26, 2025

(51) Int. Cl. H04W 4/38; H04W 4/40; H04W 12/06

(52) U.S. Cl. CPC H04W 4/38; H04W 4/40; H04W 12/06

(57) ABSTRACT

Systems and methods described herein relate to obtaining through sensors of a vehicle an interrogation inquiry requesting vehicular sensor data, receiving compliance data specifying constraints on applying the interrogation inquiry, determining responsive vehicular sensor data based on the interrogation inquiry and the compliance data, and outputting the responsive vehicular sensor data.

### TECHNICAL FIELD

The subject matter described herein relates, in general, to strategies for enabling interrogation services that allow access to vehicular sensor data.

### BACKGROUND

Vehicles may collect sensor data due to various circumstances. For example, a vehicle may be triggered to collect sensor data (e.g., video capture) when an abnormal activity has been detected (e.g., a loud sound, movement near the vehicle). While data collection can be beneficial to deter intruders, various parties besides the vehicle owner may seek to acquire sensor data recorded by a vehicle. Police or other parties may ask for permission to search the vehicular sensor data of an owner's vehicle. In some circumstances, if the owner is unavailable, search warrants, subpoenas, or some other legal authority may be relied on to seize the vehicle (e.g., by towing the vehicle to an evidence lot) so as to allow for a search of the vehicle's sensor data.

### SUMMARY

In one embodiment, a vehicle management system is disclosed. The vehicle management system includes one or more processors and a memory communicably coupled to the one or more processors. The memory stores a command module including instructions that when executed by the one or more processors cause the one or more processors to obtain through sensors of a vehicle an interrogation inquiry requesting vehicular sensor data, receive compliance data specifying constraints on applying the interrogation inquiry, determine responsive vehicular sensor data based on the interrogation inquiry and the compliance data, and output the responsive vehicular sensor data.

In one embodiment, a non-transitory computer-readable medium including instructions that when executed by one or more processors cause the one or more processors to obtain through sensors of a vehicle an interrogation inquiry requesting vehicular sensor data, receive compliance data specifying constraints on applying the interrogation inquiry, determine responsive vehicular sensor data based on the interrogation inquiry and the compliance data, and output the responsive vehicular sensor data.

In one embodiment, a method is disclosed. In one embodiment, the method includes obtaining through sensors of a vehicle an interrogation inquiry requesting vehicular sensor data, receiving compliance data specifying constraints on applying the interrogation inquiry, determining responsive vehicular sensor data based on the interrogation inquiry and the compliance data, and outputting the responsive vehicular sensor data.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of an interrogation system that is associated with enabling interrogation services that allow access to vehicular sensor data.

FIG. 3 illustrates one embodiment of a cloud computing environment within which the systems and methods described herein may operate.

FIG. 4 illustrates one example of a smart vehicle security system reacting to a triggering event.

FIG. 5 illustrates one example of an inquiry of a vehicle using an interrogation system.

FIG. 6 illustrates one example of a method for enabling interrogation services that allow access to vehicular sensor data.

### DETAILED DESCRIPTION

Systems, methods, and other embodiments are described herein associated with enabling interrogation services that allow access to vehicular sensor data. Vehicle manufacturers may offer a smart vehicle security system package (SVSS) that employs external cameras and possibly other sensors to monitor a vehicle's surroundings. When the SVSS detects suspicious activity, such as someone leaning against the vehicle or attempting to break in, the SVSS may cause the vehicle to record video footage or other sensor data, send real-time alerts to the owner, etc. While these security features enhance vehicle safety and provide peace of mind for vehicle owners, they also may result in police officers or other parties seeking access to vehicular sensor data in a manner that constrains usage of the affected vehicle.

Accordingly, vehicles are described herein that may further incorporate an interrogation system that facilitates handling of search requests when a vehicle is presented with an interrogation inquiry. The interrogation system may act to prepare vehicular sensor data for searching; authenticate credentials or parties requesting a search; evaluate whether a search should be permitted; determine responsive vehicular sensor data; redact responsive vehicular sensor data determined to be privileged; provide means for sharing responsive vehicular sensor data; and so on. Moreover, such services may be provided via a vehicular micro-cloud or other cloud networks, such that a vehicle need not be detained at a crime scene or in an evidence lot in order to comply with an interrogation inquiry.

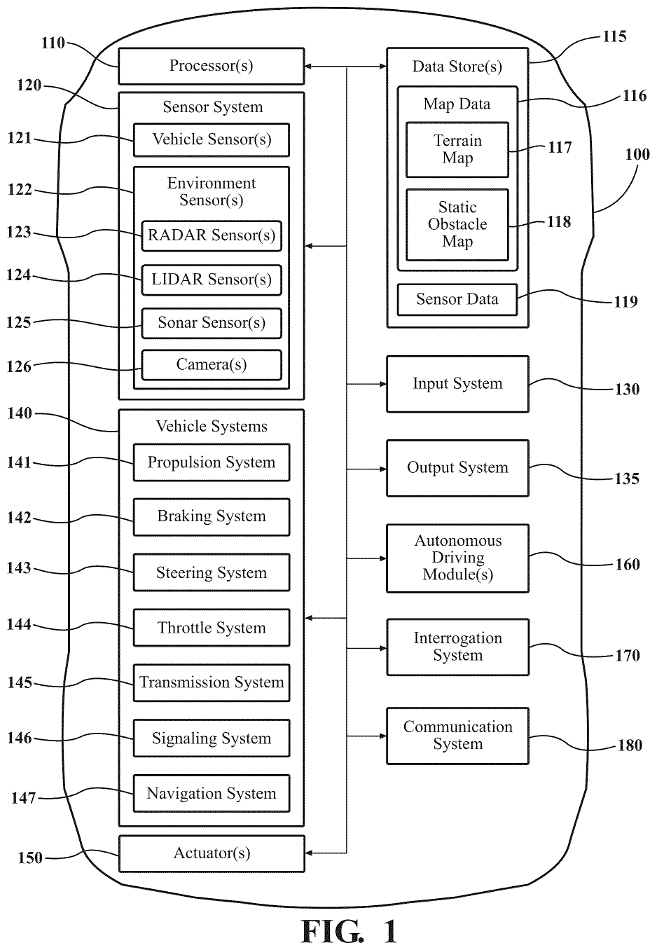

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

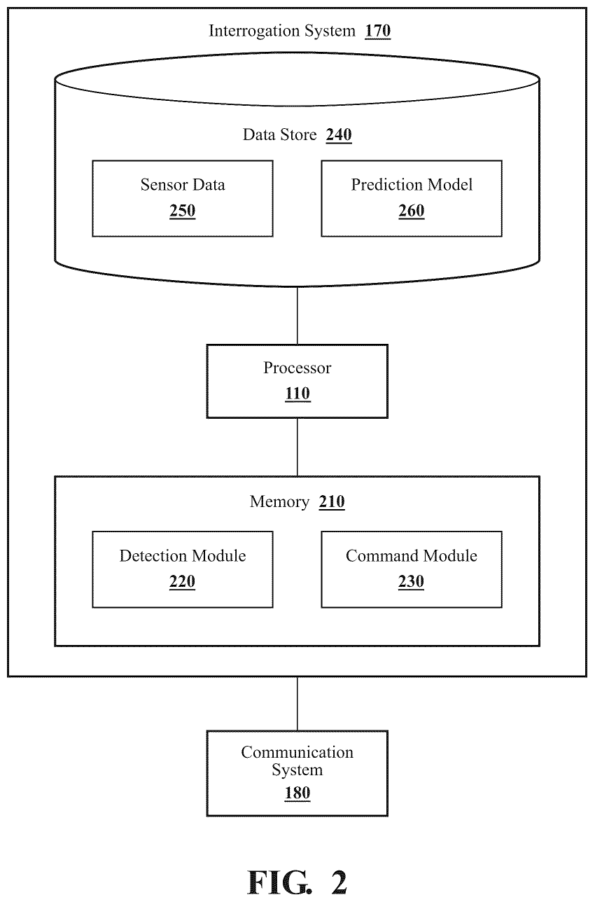

Some of the possible elements of vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes interrogation system 170 that is implemented to perform methods and other functions as disclosed herein. As will be discussed in greater detail subsequently, interrogation system 170, in various embodiments, is implemented partially within vehicle 100 and as a cloud-based service. For example, in one approach, functionality associated with at least one module of interrogation system 170 is implemented within vehicle 100 while further functionality is implemented within a cloud-based computing system.

With reference to FIG. 2, one embodiment of interrogation system 170 of FIG. 1 is further illustrated. Interrogation system 170 is shown as including processors 110 from vehicle 100 of FIG. 1. Accordingly, processors 110 may be a part of interrogation system 170, interrogation system 170 may include a separate processor from processors 110 of vehicle 100, or interrogation system 170 may access processors 110 through a data bus or another communication path. In one embodiment, interrogation system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processors 110 cause processors 110 to perform the various functions disclosed herein.

Interrogation system 170 as illustrated in FIG. 2 is generally an abstracted form of interrogation system 170 as may be implemented between vehicle 100 and a cloud-computing environment. Accordingly, interrogation system 170 may be embodied at least in part within a cloud-computing environment to perform the methods described herein.

With reference to FIG. 2, detection module 220 generally includes instructions that function to control processors 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link from one or more of the surrounding vehicles or other sources (e.g., via V2V, V2I, V2X), or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, interrogation system 170 includes a database 240. Database 240 is, in one embodiment, an electronic data structure stored in memory 210 or another data store and that is configured with routines that may be executed by processors 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

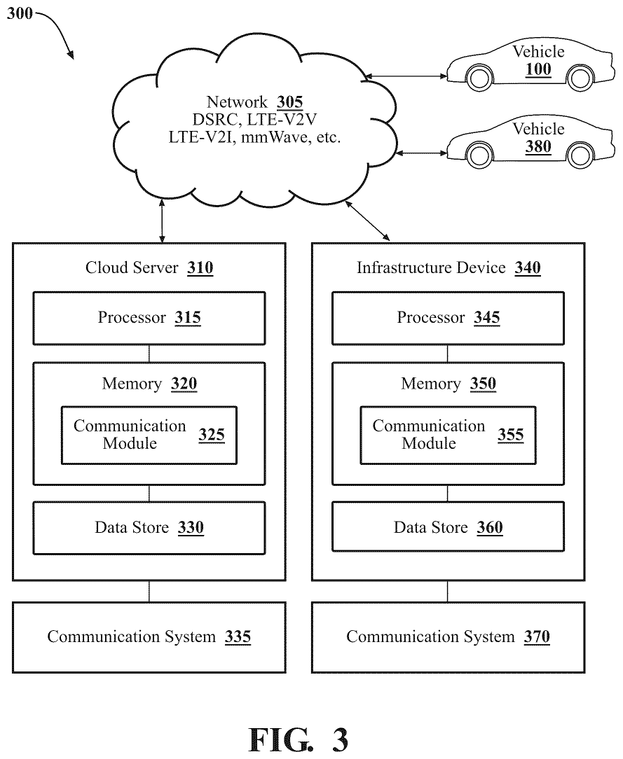

In one embodiment, command module 230 generally includes instructions that function to control the processors 110 or collection of processors in the cloud-computing environment 300 as shown in FIG. 3.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of interrogation system 170 through network 305 via communication system 335 (e.g., a network router or bridge). In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of interrogation system 170 through network 305 via communication system 370 (e.g., a network router or bridge). In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, interrogation system 170 may obtain information from cloud servers (e.g., cloud server 310), infrastructure devices (e.g., infrastructure device 340), other vehicles (e.g., vehicle 380), and any other systems connected to network 305. For example, cloud servers (e.g., cloud server 310) may be used to perform the same tasks as described herein with respect to command module 230.

In some embodiments, command module 230 may use machine learning techniques to process vehicular sensor data, an interrogation inquiry, or other actions as described herein. For example, prediction module 260 may provide one or more machine learning algorithms, such as a Convolutional Neural Network (CNN), a Recurrent Neural Network (RNN), a Long Short Term Memory Network (LSTM) a Support Vector Machine (SVM), a Vision Transformer (ViT), a Generative Adversarial Network (GAN), a Radial Basis Function Network (RBFN), a Multilayer Perceptrons (MLP), a Self Organizing Map (SOM), a Deep Belief Network (DBN), a Restricted Boltzmann Machine (RBM), an Autoencoder, etc. Such a machine learning algorithm within prediction module 260 may be trained for semantic audio, visual, or textual segmentation over vehicular sensor data from which further information is derived. Of course, in further aspects, prediction module 260 may provide different machine learning algorithms or implement a different approach to perform the associated function, which may include deep convolutional encoder-decoder architectures, or another suitable approach to generate semantic labels for different object classes represented in the vehicular sensor data.

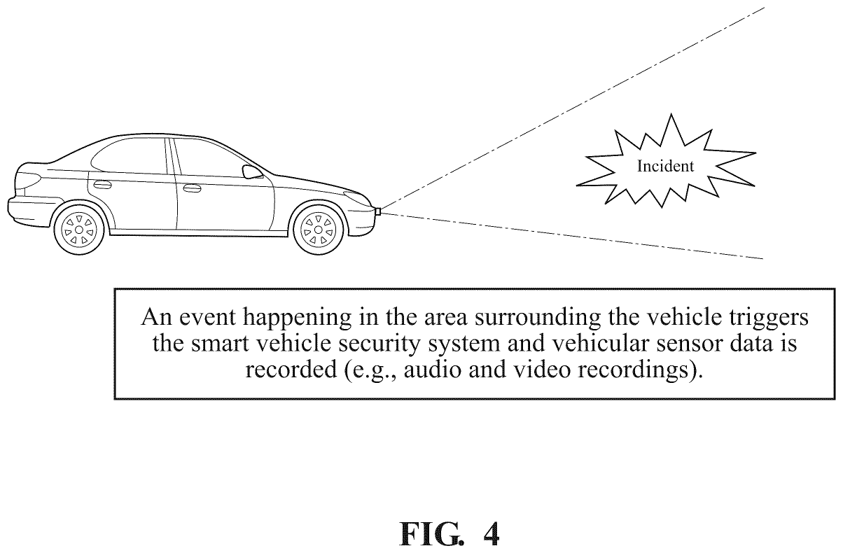

In some embodiments, such as for vehicular sensor data that was obtained by a smart vehicle security system as shown in FIG. 4, command module 230 may process vehicular sensor data (e.g., sensor data 250) for interrogative analysis. For example, command module 230 may process vehicular sensor data to include metadata characterizing the vehicular sensor data (e.g., type, location, involved parties, duration, environmental condition, triggering event). In some embodiments, command module 230 processes the vehicular sensor data as it is obtained by vehicle 100. In some embodiments, command module 230 may process the vehicular sensor data if a triggering event is detected by vehicle 100, such as motion near vehicle 100, physical impact on vehicle 100, tampering attempts on vehicle 100, proximity alerts by vehicle 100, loud noises or other unusual environmental disturbances, etc. In some embodiments, command module 230 may process the vehicular sensor data when it is determined to be relevant to an interrogation inquiry as described herein. For example, an interrogation inquiry may seek to obtain vehicular sensor data for a particular time, location, or both, such that command module 230 processes the available vehicular sensor data during that time, at that location, or both. In some embodiments, vehicular sensor data may include sensor data 250 stored on vehicle 100, sensor data 250 stored in the cloud (e.g., cloud server 310), or any other vehicular sensor data available to vehicle 100.

In some embodiments, command module 230 may receive an interrogation inquiry. An interrogation inquiry may be a message, record, or other data requesting information about vehicular sensor data or instructing that vehicular sensor data be provided. For example, in some embodiments, an interrogation inquiry may contain recordings of audio, textual, or visual data, copies of documents (e.g., police badge, search warrant), electronic access credentials, and so on. In some embodiments, the audio, textual, or visual data may be in the form of one or more questions (e.g., did this vehicle record any vehicular sensor data from 9 am to 11 am this morning?), one or more instructions (e.g., identify what types of vehicular sensor data are recorded by this vehicle), or both. In some embodiments, command module 230 may form an interrogation inquiry based on audio or visual recordings or interactions obtained via the sensors of vehicle 100.

In some embodiments, command module 230 may process an interrogation inquiry in preparation for further analysis, such as by way of semantic segmentation. For example, recordings of speech or sign language may be converted to text, gestures may be analyzed to describe them in an appropriate semantic context (e.g., person is pointing at car ahead of vehicle, person is holding up hand in the form of a stop gesture), information may be translated from one language to another (e.g., French to English), and so on.

In some embodiments, images of documents, electronic access credentials, etc. within an interrogation inquiry may be further evaluated by command module 230 to determine if any permission data is present. For example, permission data may be any information indicating a basis for privileged access to vehicular sensor data, such as information regarding the presentation of a police badge, search warrant, subpoena, or other instrument indicating legal authority, which may further include identifying one or more privileged parties that are seeking access to vehicular sensor data (e.g., the holder of the police badge, any police officer in the county of Los Angeles according to a search warrant, the party that requested the subpoena).

In some embodiments, command module 230 may detect information during processing that prompts authentication. For example, if command module 230 detects that an image contains an image of a police badge, command module 230 may undertake authentication by seeking information about the badge holder (e.g., from a third-party server maintained by a police agency). As another example, if command module 230 detects electronic access credentials, command module 230 may seek to authenticate the electronic access credentials (e.g., by contacting a trusted-party server for authentication purposes).

In some embodiments, command module 230 may receive verification data allowing command module 230 to evaluate permission data. For example, command module 230 may receive biometric data (e.g., facial images, fingerprints) based on permission data allowing command module 230 to determine that a person is a privileged party (e.g., command module 230 may perform facial recognition based on facial images received from an authentication server to determine if a person presenting a police badge is the actual person associated with the police badge). Upon receiving verification data, command module 230 may determine if the permission data associated with the verification data is valid. If it is determined not to be valid, command module 230 may reject an interrogation inquiry, request further information to perform additional authentication, etc.

In some embodiments, command module 230 may receive compliance data describing rules by which an interrogation inquiry should be evaluated. For example, compliance data may contain instructions relating to privacy rules, legal rules, contractual obligations, or other requirements specifying constraints on an interrogation inquiry or other actions that may be taken by vehicle 100 in response to an interrogation inquiry. For example, compliance data may specify that a search warrant only requiring access to vehicular sensor data recording events external to the vehicle does not allow access to vehicular sensor data recording events internal to the vehicle.

In some embodiments, command module 230 may receive the compliance data based on the location of vehicle 100, current or former vehicle occupants, current or former vehicle owners, or a combination thereof. For example, if command module 230 has information that a vehicle occupant or vehicle owner is a foreign diplomat, command module 230 may receive compliance data describing constraints on an interrogation inquiry based on diplomatic immunity or other aspects of diplomatic relations (e.g., as specified by guidelines provided by a national agency). As another example, compliance data may specify legal constraints that must be satisfied prior to command module 230 providing any response to an interrogation inquiry. For instance, a third-party organization may maintain compliance data that can be retrieved by command module 230, where such compliance data places constraints on permissible access to vehicular sensor data depending on factors such as: the source of the interrogation inquiry; any circumstances identified by the interrogation inquiry as permitting access; whether a vehicle is within the jurisdiction of any authority asserted by an interrogation inquiry; any privileges that may prevent access (e.g., attorney-client privilege), or any other determination based on the information associated with an interrogation inquiry that could affect permissibility.

In some embodiments, compliance data may instruct command module 230 to send a notification regarding an interrogation inquiry. For example, command module 230 may send a notification to a vehicle owner, vehicle occupant, or another party identified by the compliance data, wherein the notification may identify the source of an interrogation inquiry, the data being requested, the question or instructions being presented by the interrogation inquiry, the nature of the permission data being provided (e.g., badge, search warrant, electronic access credentials), whether any permission data has been validated (e.g., by a validation action), and so on. In some embodiments, the notification may include a confirmation request. In some embodiments, if command module 230 receives a positive acknowledgement of the confirmation request, then command module 230 may be authorized to proceed with the interrogation inquiry. In some embodiments, if command module 230 receives a negative acknowledgement of the confirmation request, then command module 230 may be authorized to deny the interrogation inquiry to the extent it is permitted to do so (e.g., permission data may not allow for such a denial to take effect, but may nonetheless allow command module 230 to record that a denial was received in response to the interrogation inquiry).

In some embodiments, command module 230 may search the vehicular sensor data based on an interrogation inquiry. For example, command module 230 may use a large language model (LLM) or other types of artificial intelligence provided by prediction module 260 to evaluate whether any vehicular sensor data satisfies questions or instructions contained within an interrogation inquiry when the vehicular sensor data and questions or instructions are provided to the LLM. Irrespective of which approach the prediction module 260 implements, command module 230 via the prediction module 260 may provide an output that identifies one or more sets of vehicular sensor data responsive to the interrogation inquiry. In some embodiments, command module 230 may identify the one or more sets of vehicular sensor data based on the type of sensor data recorded, the time of the recording, metadata associated with the sensor data, a summary of what is present in the sensor data, the length of the sensor data, the size of the sensor data, a relevance metric, etc.

In some embodiments, command module 230 may search the vehicular sensor data based on an interrogation inquiry subject to compliance data. For example, an interrogation inquiry may be evaluated by command module 230 prior to performing a search to ensure that an interrogation inquiry is valid (e.g., by way of authentication or other requirements specified by any compliance data). As another example, an interrogation inquiry may be evaluated by command module 230 prior to performing a search to remove impermissible questions or instructions based on compliance data. An interrogation inquiry, for instance, may be provided as an input to an LLM with instructions from the compliance data to remove any invalid aspect of a question or instruction (e.g., any question or instruction that seeks to obtain vehicular sensor data marked as privileged). As yet another example, an interrogation inquiry may be evaluated by command module 230 during a search by including instructions from the compliance data as an additional input to an LLM when seeking one or more sets of responsive vehicular sensor data as an output. For instance, in addition to the information from the interrogation inquiry and the vehicular sensor data, the LLM may also receive as input that certain types of sensor data (e.g., any sensor data recording video or audio within a vehicle) should be excluded based on compliance data.

In some embodiments, command module 230 may also utilize compliance data to adjust one or more sets of responsive vehicular sensor data. For example, a predictive model based on the vehicular sensor data and instructions from the compliance data as inputs may generate output that deletes or modifies the responsive vehicular sensor data. For instance, portions of responsive vehicular sensor data may be redacted to exclude text, audio, or visual information that instructions from the compliance data indicate are outside the scope of potentially responsive vehicular sensor data. Accordingly, if a police officer is asking for information about an event external to vehicle 100, any responsive vehicular sensor data may be processed by command module 230 to exclude information of events within vehicle 100 (e.g., conversations, gestures). In addition, compliance data may contain information about words, situations, or other semantic/contextual triggers that if detected in the responsive vehicular sensor data results in at least a portion of any responsive vehicular sensor data being marked as privileged. For example, based on compliance data command module 230 may rely on semantic/contextual triggers (e.g., “attorney”, “court”, “does the conversation discuss legal issues?”) to evaluate whether a portion of any responsive vehicular sensor data should be redacted and marked privileged.

In some embodiments, vehicle 100 before performing a search for responsive vehicular sensor data may query another vehicle to determine if such a search should proceed. For example, if command module 230 detects that an interrogation inquiry seeks data that may be recorded by a nearby vehicle (e.g., “please provide any audio or visual data of the people talking in the vehicle behind you), command module 230 may contact such a vehicle to request a determination whether such vehicular sensor data if provided by the other vehicle would involve vehicle sensor data marked privileged. Compliance data may for instance contain an instruction that any interrogation inquiry seeking data from a first vehicle about events within the interior of a second vehicle must require the second vehicle to make and share a determination about whether such an interrogation inquiry results in responsive vehicular sensor data of the second vehicle that is marked privileged. In this manner, communication between connected vehicles may be used to prevent abuse of vehicular sensor data in another vehicle to evade privilege designations by vehicle 100.

In some embodiments, command module 230 may receive a selection of one or more sets of responsive vehicular sensor data, wherein such a selection may also include instructions of where to upload the one or more sets of responsive vehicular sensor data. For example, the selection may provide access credentials allowing vehicle 100 to transmit the selected set(s) of responsive vehicular sensor data to another vehicle or server (e.g., via a cloud network). In some embodiments, if an instruction of where to upload such data is not provided with a selection, then command module 230 may perform an inquiry as to where it should send the data. For example, command module 230 may instruct vehicle 100 to ask a police officer where to send the data, then analyze an audio or visual recording given in response by the police officer to determine an upload location. In some embodiments, command module 230 may provide instructions via vehicle 100 on how to download the data, such as causing vehicle 100 to display a QR code that initiates a download, providing information on how to connect via Wi-Fi or Bluetooth to establish a direct transfer, etc.

In some embodiments, command module 230 may preserve any vehicular sensor data that was determined to be responsive to an interrogation inquiry. For example, after a police department receives an upload of selected set(s) of responsive vehicular sensor data, such data may be preserved by vehicle 100 for subsequent examination by a vehicle owner, vehicle occupant, etc. In some embodiments, command module 230 may maintain a privilege log identifying any responsive vehicle sensor data that was redacted by command module 230 and the basis for it being withheld (e.g., internal video recording—outside scope of search; internal audio recording—attorney client privilege). In some embodiments, command module 230 when outputting responsive vehicular sensor data may also include a privilege log for any sensor data excluded from the responsive vehicular sensor data. In some embodiments, command module 230 may preserve any vehicular sensor data that was determined to be privileged in response to an interrogation inquiry.

In some embodiments, vehicle 100 may receive a handling order to be applied to the selected set(s) of responsive vehicular sensor data. For example, a handling order may instruct vehicle 100 to erase any selected set(s) of responsive vehicular sensor data (e.g., because the vehicular sensor data involves a privacy concern, a national security concern, etc.). As another example, a handling order may instruct vehicle 100 to limit access to any selected set(s) of responsive vehicular sensor data (e.g., because the subject of an investigation if able to access such data may commit further crimes, such as intimidation of a witness that was recorded by vehicle 100).

In some embodiments, a vehicle when subject to an interrogation inquiry may be able to move about while complying with the interrogation inquiry. For example, if only vehicular sensor data is of interest than it may not be necessary for a vehicle complying with an interrogation inquiry to be detained, such as by police officer at a crime scene or at an evidence lot. Accordingly, vehicle 100 may comply with an interrogation inquiry via a cloud connection as the vehicle is moved about. In some embodiments, the movement of vehicle 100 may be constrained by a mobile restriction order that instructs command module 230 to limit the movement of vehicle 100 to a specific area while processing of the interrogation inquiry is ongoing. In some embodiments, vehicular sensor data may be offloaded to other vehicles or servers (e.g., via a vehicular micro-cloud or other cloud networks) such that vehicle 100 is free to leave once the vehicular sensor data can be processed as described herein on such other vehicles or servers.

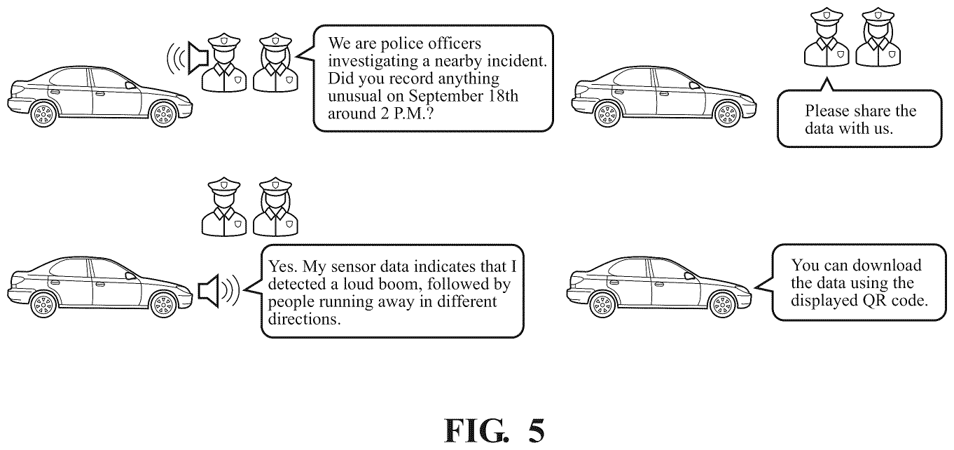

An example of how the methods and systems described herein can be used to facilitate a process by which a vehicle can be approached by police, an interrogation inquiry be given via the vehicle's sensors, and then acted on by the vehicle is shown in FIG. 5.

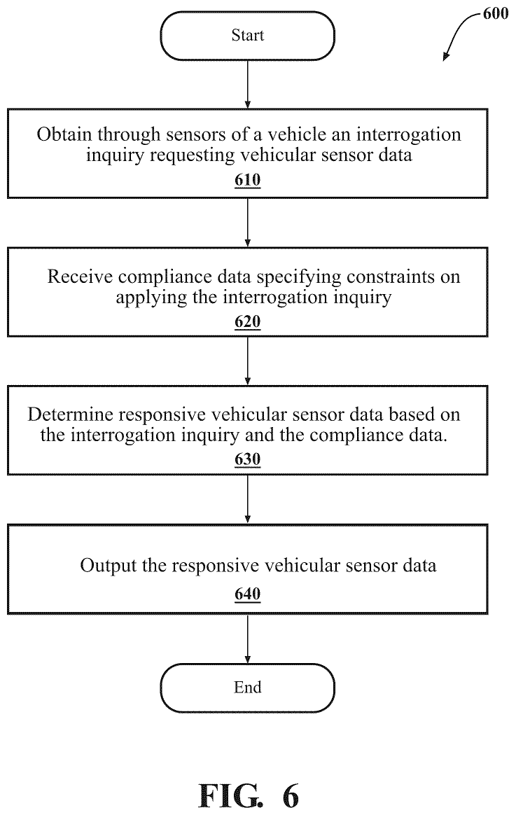

FIG. 6 illustrates a flowchart of a method 600 that is associated with strategies for enabling interrogation services that allow access to vehicular sensor data. Method 600 will be discussed from the perspective of the interrogation system 170 of FIGS. 1 and 2. While method 600 is discussed in combination with the interrogation system 170, it should be appreciated that the method 600 is not limited to being implemented within interrogation system 170 but is instead one example of a system that may implement method 600.

At step 610, command module 230 may obtain through sensors of a vehicle an interrogation inquiry requesting vehicular sensor data. For example, a police officer may approach a vehicle and present a badge to a vehicle camera and give verbal inquiry to the vehicle regarding any vehicular sensor data it may contain. As another example, a police officer may present a search warrant to a vehicle camera describing a search of the vehicular sensor data to be performed on the behalf of the police officer. In some embodiments, command module 230 may process such textual, audio, or visual data (e.g., through semantic segmentation) to receive an interrogation inquiry.

At step 620, command module 230 may receive compliance data specifying constraints on applying the interrogation inquiry. For example, based on the vehicle's location, vehicle owner, recent vehicle occupants, or other factors, command module 230 may retrieve compliance data to evaluate an interrogation inquiry. For example, compliance data may specify the location the vehicle must be within for command module 230 to accept an interrogation inquiry as valid. As another example, compliance data may set restrictions on response vehicular sensor data that may be provided based on an interrogation inquiry (e.g., no interior recordings of a vehicle).

At step 630, command module 230 may determine responsive vehicular sensor data based on the interrogation inquiry and the compliance data. For example, command module 230 may utilize machine learning algorithms stored in prediction module 260 to evaluate vehicular sensor data according to an interrogation inquiry and any compliance data and receive as output from prediction module 260 one or more sets of responsive vehicle sensor data.

At step 640, command module 230 may output the responsive vehicular sensor data. For example, command module 230 may instruct vehicle 100 to display a QR code or other object that facilitates downloading of the responsive vehicle sensor data. As another example, command module 230 may instruct vehicle 100 to display or announce instructions on how to download responsive vehicle sensor data (e.g., by connecting via wireless and initiating a direct transfer). As yet another example, command module 230 may instruct vehicle 100 to request where the data should be sent and record the answer, such that command module 230 may analyze the answer to determine a location to send the responsive vehicle sensor data (e.g., an email address, an app, a URL, an Internet address) and then send such data to that location.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117 Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, interrogation system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, interrogation system 170, automated driving module(s) 160, or any combination thereof may control some or all of these vehicle system(s) 140 and, thus, may be partially or fully autonomous.

Processor(s) 110, interrogation system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, interrogation system 170, automated driving module(s) 160, or any combination thereof may control the direction, speed, or both of vehicle 100. Processor(s) 110, interrogation system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include communication system 180. Communication system 180 may be any element or combination of elements operable to communicate data with another communication system. Any suitable communication system may be used. For instance, communication system 180 may support V2V, V2I, V2X, Wi-Fi, and Bluetooth, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving module(s) 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with interrogation system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
obtain, through sensors of a vehicle, an interrogation inquiry requesting vehicular sensor data;
receive compliance data specifying constraints on applying the interrogation inquiry;
determine responsive vehicular sensor data based on the interrogation inquiry and the compliance data; and
output the responsive vehicular sensor data.

2. The system of claim 1, wherein the machine-readable instructions further include an instruction to authenticate permission data within the interrogation inquiry.

3. The system of claim 2, wherein the machine-readable instruction to determine the responsive vehicular sensor data only occurs if the permission data is determined to be authentic.

4. The system of claim 1, wherein the machine-readable instruction to receive the compliance data includes to receive a constraint based on vehicle location.

5. The system of claim 1, wherein the machine-readable instructions further include an instruction to adjust the responsive vehicular sensor data based on the compliance data.

6. The system of claim 5, wherein the machine-readable instructions to adjust the responsive vehicular sensor data based on the compliance data causes a portion of the responsive vehicular sensor data to be marked as privileged.

7. The system of claim 1, wherein the machine-readable instruction to determine the responsive vehicular sensor data is performed without the vehicle being subject to movement constraints.

8. A non-transitory computer-readable medium including instructions that when executed by one or more processors cause the one or more processors to:
obtain, through sensors of a vehicle, an interrogation inquiry requesting vehicular sensor data;
receive compliance data specifying constraints on applying the interrogation inquiry;
determine responsive vehicular sensor data based on the interrogation inquiry and the compliance data; and
output the responsive vehicular sensor data.

9. The non-transitory computer-readable medium of claim 8, wherein the instructions further include an instruction to authenticate permission data within the interrogation inquiry.

10. The non-transitory computer-readable medium of claim 9, wherein the instruction to determine the responsive vehicular sensor data only occurs if the permission data is determined to be authentic.

11. The non-transitory computer-readable medium of claim 8, wherein the instructions to receive the compliance data includes to receive a constraint based on vehicle location.

12. The non-transitory computer-readable medium of claim 8, wherein the instruction further include an instruction to adjust the responsive vehicular sensor data based on the compliance data.

13. The non-transitory computer-readable medium of claim 12, wherein the instruction to adjust the responsive vehicular sensor data based on the compliance data causes a portion of the responsive vehicular sensor data to be marked as privileged.

14. A method, comprising:
obtaining, through sensors of a vehicle, an interrogation inquiry requesting vehicular sensor data;
receiving compliance data specifying constraints on applying the interrogation inquiry;
determining responsive vehicular sensor data based on the interrogation inquiry and the compliance data; and
outputting the responsive vehicular sensor data.

15. The method of claim 14, further comprising authenticating permission data within the interrogation inquiry.

16. The method of claim 15, wherein determining the responsive vehicular sensor data only occurs if the permission data is determined to be authentic.

17. The method of claim 14, wherein receiving the compliance data includes to receive a constraint based on vehicle location.

18. The method of claim 14, further comprising adjusting the responsive vehicular sensor data based on the compliance data.

19. The method of claim 18, wherein adjusting the responsive vehicular sensor data based on the compliance data causes a portion of the responsive vehicular sensor data to be marked as privileged.

20. The method of claim 14, wherein determining the responsive vehicular sensor data is performed without the vehicle being subject to movement constraints.
